(19) United States
(12) Patent Application Publication
(10) Pub. No.: US 2021/0203602 A1
(43) Pub. Date: Jul. 1, 2021

(54) ANALYZER AND ANALYSIS METHOD

(71) Applicant: Nippon Telegraph and Telephone Corporation, Tokyo (JP)

(72) Inventors: Naoyuki Tanji, Musashino-shi, Tokyo (JP); Naoki Take, Musashino-shi, Tokyo (JP); Kensuke Takahashi, Musashino-shi, Tokyo (JP); Hiroyuki Tanaka, Musashino-shi, Tokyo (JP); Nobuo Onai, Musashino-shi, Tokyo (JP); Hiroshi Kato, Musashino-shi, Tokyo (JP); Hiroyuki Yazaki, Musashino-shi, Tokyo (JP)

(21) Appl. No.: 17/048,759

(22) PCT Filed: Apr. 1, 2019
(86) PCT No.: PCT/JP2019/014509

§ 371 Date: Oct. 19, 2020

(30) Foreign Application Priority Data
Apr. 20, 2018 (JP) 2018-081270

(51) Int. Cl. H04L 12/803; H04L 12/851; H04L 12/24

(52) U.S. Cl. CPC H04L 47/125; H04L 41/0816; H04L 41/5009; H04L 47/2425

(57) ABSTRACT

[Problem] Reduce operator's maintenance burden related to parameter tuning.

[Solution] An analysis apparatus 1 for analyzing a service on a network is provided, the analysis apparatus including: a storage unit 30 configured to store monitoring information in which an analysis logic for an apparatus disposed on the network and a parameter used to execute the analysis logic are set according to each type of the apparatus and for each performance of the apparatus, and an application rule for when performing parameter tuning on each of a plurality of apparatuses used for providing the service and disposed on the network; and a processing unit 20 configured to apply the application rule to service configuration information indicating a network configuration of the plurality of apparatuses used for providing the service and disposed on the network, compare the service configuration information with the monitoring information, and select an equal analysis logic and an equal parameter to a plurality of the apparatuses having the corresponding type and performance out of the apparatuses indicated in the service configuration information.

### TECHNICAL FIELD

The present disclosure relates to an analysis apparatus and an analysis method.

### BACKGROUND ART

There are many types of analysis logics that can be applied to a service to perform failure detection and failure recovery of a service on a network. When performing failure detection or failure recovery for a specific service, it is necessary to select at least one type of data and analysis logic to be analyzed. The selection itself of the data and the analysis logic is out of the scope of the present disclosure, and thus the description is omitted. Additionally, in order to obtain an intended result using the selected analysis logic, it is necessary to perform parameter tuning on the analysis logic. The parameter tuning refers to determining a combination of a target apparatus on the network, the analysis logic selected for the target apparatus, and a parameter used to execute the selected analysis logic. By the parameter tuning, the selected analysis logic can be optimized.

Note that Patent Literature 1 discloses a technology for constructing a network service. According to Patent Literature 1, it is possible to acquire a service configuration of the service which becomes a subject of the failure detection and the failure recovery.

### CITATION LIST

### Patent Literature

Patent Literature 1: JP 2017-143452 A

### SUMMARY OF THE INVENTION

### Technical Problem

In parameter tuning, it is necessary to analyze a huge amount of data obtained by monitoring a network in detail. However, in known technologies including Patent Literature 1, the parameter tuning is left to human operation such as an operator's experience. Accordingly, the parameter tuning imposes a heavy maintenance burden on the operator.

In view of such a background, an object of the present disclosure is to reduce the maintenance burden of the operator related to the parameter tuning.

### Means for Solving the Problem

In order to solve the problem described above, the disclosure described in the first aspect provides an analysis apparatus for analyzing a service on a network, the analysis apparatus including: a storage unit configured to store monitoring information in which an analysis logic for an apparatus disposed on the network and a parameter used to execute the analysis logic are set according to each type of the apparatus and for each performance of the apparatus, and an application rule for when performing parameter tuning on each of a plurality of apparatuses used for providing the service and disposed on the network; and a processing unit configured to acquire service configuration information indicating a network configuration of the plurality of apparatuses used for providing the service and disposed on the network, apply the application rule to the service configuration information, compare the service configuration information with the monitoring information, and select an equal analysis logic and an equal parameter to a plurality of the apparatuses having the corresponding type and performance out of the apparatuses indicated in the service configuration information.

Further, the disclosure described in the third aspect provides an analysis method used by an analysis apparatus for analyzing a service on a network, the analysis apparatus including a storage unit configured to store monitoring information in which an analysis logic for an apparatus disposed on the network and a parameter used to execute the analysis logic are set according to each type of the apparatus and for each performance of the apparatus, and an application rule for when performing parameter tuning on each of a plurality of apparatuses used for providing the service and disposed on the network, the analysis method including: acquiring service configuration information indicating a network configuration of the plurality of apparatuses used for providing the service and disposed on the network; applying the application rule to the service configuration information; comparing the service configuration information with the monitoring information; and selecting an equal analysis logic and an equal parameter to a plurality of the apparatuses having the corresponding type and performance out of the apparatuses indicated in the service configuration information.

According to the disclosure described in the first and third aspects, the parameter tuning based on an identity of a type and performance of an apparatus is executed using the service configuration information. Accordingly, the parameter tuning of the analysis logic can be automated.

Accordingly, it is possible to reduce the maintenance burden on the operator related to the parameter tuning.

Further, the disclosure described in the second aspect provides the analysis apparatus described in the first aspect, in which the apparatuses indicated in the service configuration information include a load balancer, the analysis logic includes an analysis logic directed to multiple apparatuses for a plurality of the apparatuses under control of the load balancer, the parameter includes a parameter directed to multiple apparatuses used to execute the analysis logic directed to multiple apparatuses, and the application rule includes a rule requesting the plurality of apparatuses under control of the load balancer to select the analysis logic directed to multiple apparatuses and the parameter directed to multiple apparatuses.

According to the disclosure described in the second aspect, it is possible to automate parameter tuning focusing on load distribution.

### Effects of the Invention

According to the present disclosure, it is possible to reduce the maintenance burden on the operator related to the parameter tuning.

### BRIEF DESCRIPTION OF DRAWINGS

FIG. 1 is a functional configuration diagram of an analysis apparatus of the present embodiment.

FIG. 2 is an example of service configuration information.

FIG. 3 is an example of monitoring information.

FIG. 4 is an example of a parameter selection result.

FIG. 5 is a flowchart illustrating parameter tuning processing.

### DESCRIPTION OF EMBODIMENTS

Hereinafter, an embodiment for carrying out the present disclosure (hereinafter, referred to as an “embodiment”) will be described referring to the drawings.

Configuration

An analysis apparatus of the present embodiment is an apparatus that performs failure detection and failure recovery of a service using an analysis logic for an apparatus disposed on a network to which the service is provided. The analysis logic performing the failure detection and the failure recovery of a service includes, for example, a logic for determining an abnormality based on a fixed threshold value, a logic for determining the abnormality in consideration of a periodicity of data (e.g., a SARIMA model), a logic for determining the abnormality in consideration of a periodicity of data and an entire fluctuation trend (e.g., the Holt-Winters method), a logic for determining the abnormality by combining a plurality of data sequences (e.g., a correlation coefficient), and a logic for determining the abnormality by deep learning (e.g., Auto-Encoder), but is not limited to these.

Further, the present embodiment explains, as an example, parameter tuning in which a parameter is selected by focusing on load distribution.

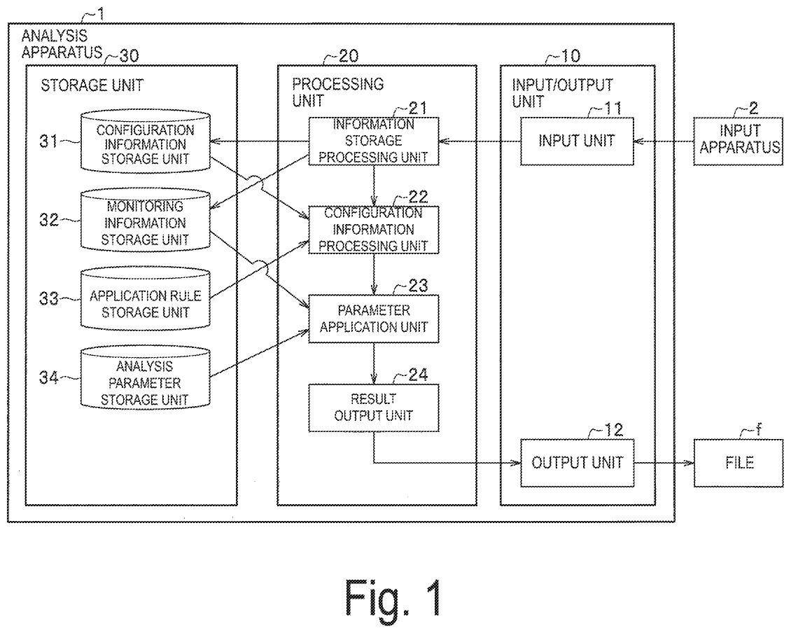

As illustrated in FIG. 1, the analysis apparatus 1 of the present embodiment includes hardware such as an input/output unit 10, a processing unit 20, and a storage unit 30. A Central Processing Unit (CPU) as a specific example of the processing unit 20 executes a program read on a memory as a specific example of the storage unit 30 to implement a function of the analysis apparatus 1 according to the present embodiment.

The input/output unit 10 includes an input unit 11 and an output unit 12. Further, the processing unit 20 includes an information storage processing unit 21, a configuration information processing unit 22, a parameter application unit 23, and a result output unit 24. The storage unit 30 includes a configuration information storage unit 31, a monitoring information storage unit 32, an application rule storage unit 33, and an analysis parameter storage unit 34.

The input unit 11 is an interface that acquires information input from the input apparatus 2. The input apparatus 2 is, for example, a management console operated by an operator, an Element Management System (EMS) apparatus, or a Network Management System (NMS) apparatus, but is not limited to these.

The output unit 12 outputs a processing result of the processing unit 20. The processing result of the processing unit 20 is output as, for example, a file f, but is not limited to this. A content of the processing result of the processing unit 20 is, for example, a processing result of the parameter tuning, but is not limited to this.

The information storage processing unit 21 stores information acquired by the input unit 11 in the storage unit 30. The information acquired by the information storage processing unit 21 from the input unit 11 is, for example, service configuration information and monitoring information described later, but is not limited to this. The information storage processing unit 21 stores the service configuration information in the configuration information storage unit 31. Further, the information storage processing unit 21 stores the monitoring information in the monitoring information storage unit 32. The information storage processing unit 21 outputs a processing result, when the service configuration information and the monitoring information are stored, to the configuration information processing unit 22.

The configuration information processing unit 22 applies an application rule (described later) stored in the application rule storage unit 33 to the service configuration information stored in the configuration information storage unit 31. The configuration information processing unit 22 outputs to the parameter application unit 23 a processing result after applying the application rule to the service configuration information.

The parameter application unit 23 performs the parameter tuning on the processing result of the configuration information processing unit 22, and generates a parameter selection result (described later). The parameter application unit 23 uses the monitoring information stored in the monitoring information storage unit 32 and the parameter stored in the analysis parameter storage unit 34 at the time of the parameter tuning. The parameter application unit 23 outputs the parameter selection result to the result output unit 24.

The result output unit 24 outputs the parameter selection result to the output unit 12.

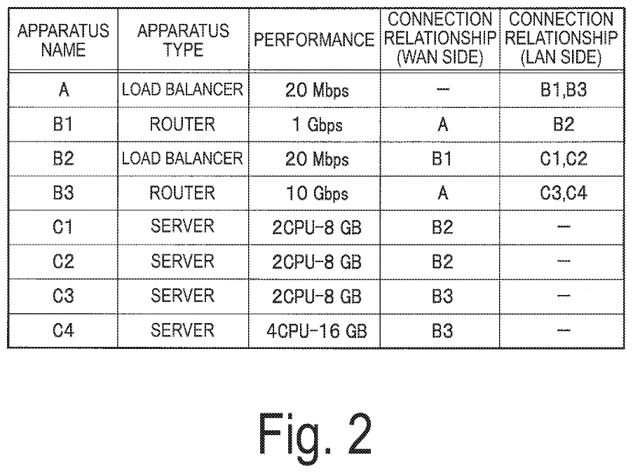

The configuration information storage unit 31 stores the service configuration information. The service configuration information is used to provide a service to be analyzed, indicating a network configuration of a plurality of apparatuses disposed on the network. As illustrated in FIG. 2, the service configuration information includes an item such as “apparatus name”, “apparatus type”, “performance”, “connection relationship (Wide Area Network (WAN) side)”, and “connection relationship (Local Area Network (LAN) side)”, and various values are determined for an apparatus.

The “apparatus name” column stores a name of a target apparatus.

The “apparatus type” column stores a type (role) of the target apparatus. FIG. 2 illustrates a load balancer, a router, and a server as a type of the apparatus, but these are examples and the present disclosure is not limited to these.

The “performance” column stores a value indicating a specification of the target apparatus according to the apparatus type. A value of a communication speed (Mbps) is stored for the load balancer. The value of the communication speed (Gbps) is stored for the router. A value indicating a set of the number of cores and a memory capacity (GB) is stored for the server.

The column of “connection relationship (Wide Area Network (WAN) side)” stores a name of an apparatus connected upstream of the target apparatus.

The column of “connection relationship (Local Area Network (LAN) side)” stores a name of an apparatus connected downstream of the target apparatus.

A content of the service configuration information can be determined, for example, by using a technology for constructing a network service described in Patent Literature 1. That is, the operator can grasp a plurality of apparatuses used to provide the service to be analyzed.

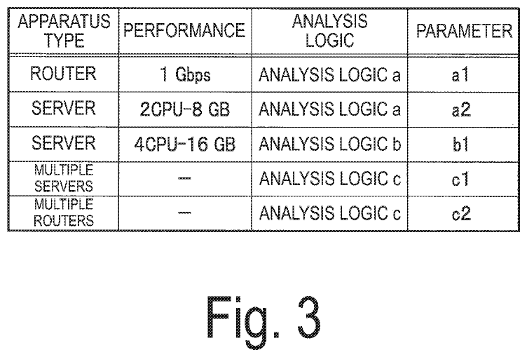

The monitoring information storage unit 32 stores the monitoring information. The monitoring information is information in which the analysis logic for the apparatus disposed on the network and the parameter used to execute the analysis logic are set according to an apparatus type and an apparatus performance. The monitoring information records the analysis logic and the parameter used when the apparatus disposed on the network is monitored in the past (at the time of the analysis performed before the current analysis using the analysis logic). As illustrated in FIG. 3, the monitoring information includes an item such as “apparatus type”, “performance”, “analysis logic”, and “parameter”, and various values are determined for an apparatus type.

The “apparatus type” column stores a type (role) of the apparatus to be monitored. In FIG. 3, (one) “router”, (one) “server”, “multiple servers”, and “multiple routers” are described as apparatus types, but these are examples and the apparatus types are not limited to these. Note that “multiple servers” means a group of servers under control of one load balancer. Further, “multiple routers” means a group of routers under control of one load balancer.

The “performance” column stores a value indicating a specification according to the apparatus type. The value of the communication speed (Gbps) is stored for the router (e.g., 1 Gbps). A value indicating a set of the number of cores and the memory capacity (GB) (e.g., 2 CPU-8 GB) is stored for the server. In the present embodiment, “performance” is not defined for multiple servers and multiple routers, but may be defined in a predetermined manner.

The value stored in the “performance” column is a lower limit value, and includes an apparatus type having a value equal to or higher than the value. For example, “1 Gbps” stored in the “performance” column of the router means that the router having a communication speed of 1 Gbps or more corresponds to the value. Further, when a specific apparatus in the service configuration information corresponds to two or more “apparatus type” columns of the monitoring information, and also corresponds to a condition indicated by a value stored in the “performance” column corresponding to each “apparatus type” column, it is assumed that the apparatus corresponds to the apparatus type having a larger lower limit. For example, a server having a performance of “4CPU-16 GB” is a “server” in the “apparatus type” column of the monitoring information, also corresponds to a record of “2CPU-8 GB” (second from the top in FIG. 3) in the corresponding “performance” column, also corresponds to a record of “4CPU-16 GB” (third from the top in FIG. 3) in the corresponding “performance” column, but is considered to correspond to the latter half (third from the top) of the records.

The “analysis logic” column stores a name of the analysis logic used for the apparatus type indicated in the “apparatus type” column. “Analysis logic c” illustrated in FIG. 3 is an analysis logic directed to multiple apparatuses for multiple servers and multiple routers.

The “parameter” column stores a name of the parameter for executing the analysis logic indicated in the “analysis logic” column. For each analysis logic, multiple parameters to be set are prepared, and the names of the parameters selected in the past are stored in the “parameter” column. Further, the type of the parameter is determined according to the analysis logic. For example, when the analysis logic is the Holt-Winters method, the parameter is a cycle, and multiple parameters representing the cycle are prepared. When the Holt-Winters method is selected in the past, at least one parameter representing the cycle is selected, the Holt-Winters method is stored in the “analysis logic” column, and the selected parameter is stored in the “parameter” column.

The parameters “c1” and “c2” illustrated in FIG. 3 are parameters directed to multiple apparatuses used to execute the analysis logic directed to multiple apparatuses.

Retuming to FIG. 1, the application rule storage unit 33 stores the application rule applied to the service configuration information. There are various types of application rules stored by the application rule storage unit 33, and the application rule for performing the parameter tuning to select a parameter by focusing on the load distribution is also included. In the case of the parameter tuning in which the parameter is selected by focusing on the load distribution, the applicable rule combining the following two, a rule (1) and a rule (2) can be prepared.

Rule (1): The service configuration information is compared with the past monitoring information.

When the apparatus type and the performance match (correspond), the same analysis logic and the same parameter are selected.

Rule (2): For the apparatus under control of the load balancer, the analysis logic (analysis logic directed to multiple apparatuses) and the parameter (parameter directed to multiple apparatuses) that can analyze multiple targets are selected.

In the rule (1), when the analysis logic that has been selected in a previous stage of the parameter tuning is the same as one of the analysis logics recorded in the monitoring information, the analysis logic and the parameter recorded in the monitoring information is used for the corresponding apparatus whose type and performance match. Meanwhile, in the rule (1), when the analysis logic that has been selected in the previous stage of the parameter tuning is different from any of the analysis logics recorded in the monitoring information, the analysis apparatus 1 performs the following processing.

The same analysis logic that has been selected in the previous stage of the parameter tuning is selected again for the plurality of apparatuses with the same type and the same performance, and the same parameter to execute the analysis logic that is selected again is selected for the plurality of apparatuses having the same type and the same performance. The selection of the same parameter may be based on, for example, an arbitrary determination by the operator.

As an example of the application rule for performing the parameter tuning other than the parameter tuning for selecting the parameter by focusing on load distribution, a rule including the rule (1) described above can be prepared. The application rule storage unit 33 may store such an application rule.

The analysis parameter storage unit 34 stores the parameter to execute the analysis logic. The parameters recorded in the monitoring information can be determined from the parameter stored in the analysis parameter storage unit 34.

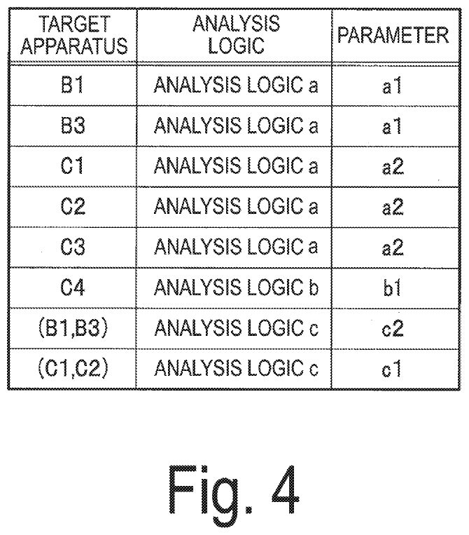

The configuration information processing unit 22 applies the application rule described above to the service configuration information (FIG. 2), the parameter application unit 23 refers to the past monitoring information (FIG. 3) with respect to the application result, and thus the parameter selection result illustrated in FIG. 4 is output.

A target apparatus “B1” is a router and has a performance of “1 Gbps” (FIG. 2). Accordingly, the target apparatus B1 corresponds to the first record from the top of the monitoring information (FIG. 3), and an “analysis logic a” and a parameter “a1” indicated in the first record are selected.

A target apparatus “B3” is a router and has a performance of “10 Gbps” (FIG. 2). Accordingly, the target apparatus B3 corresponds to the first record from the top of the monitoring information (FIG. 3), and the “analysis logic a” and the parameter “a1” indicated in the record are selected.

A target apparatus “C1” is a server and has a performance of “2CPU-8 GB” (FIG. 2). Accordingly, the target apparatus C1 corresponds to the second record from the top of the monitoring information (FIG. 3), and the “analysis logic a” and the parameter “a2” indicated in the record are selected.

A target apparatus “C2” is a server and has a performance of “2CPU-8 GB” (FIG. 2). Accordingly, the target apparatus C2 corresponds to the second record from the top of the monitoring information (FIG. 3), and the “analysis logic a” and the parameter “a2” indicated in the record are selected.

A target apparatus “C3” is a server and has a performance of “2CPU-8 GB” (FIG. 2). Accordingly, the target apparatus C3 corresponds to the second record from the top of the monitoring information (FIG. 3), and the “analysis logic a” and the parameter “a2” indicated in the record are selected.

A target apparatus “C4” is a server and has a performance of “4CPU-16 GB” (FIG. 2). Accordingly, the target apparatus C4 corresponds to the third record from the top of the monitoring information (FIG. 3), and the “analysis logic b” and the parameter “bl” indicated in the record are selected.

Target apparatuses “(B1, B3)” are multiple routers under control of a load balancer “A” (FIG. 2). Accordingly, the target apparatuses “(B1, B3)” correspond to the fifth record from the top of the monitoring information (FIG. 3), and the “analysis logic c” and the parameter “c2” indicated in the record are selected.

Target apparatuses “(C1, C2)” are multiple servers under control of a load balancer “B2” (FIG. 2). Accordingly, the target apparatuses “(C1, C2)” correspond to the fourth record from the top of the monitoring information (FIG. 3), and the “analysis logic c” and the parameter “c1” indicated in the record are selected.

The apparatuses “A” and “B2” are load balancers (FIG. 2), and thus selections of the analysis logic and the parameter are unnecessary and are not included in the parameter selection result. As described above, the parameter tuning based on the apparatus type (role) and the same performance is executed, and the result output unit 24 outputs the execution result.

All of the various values included in the parameter selection result illustrated in FIG. 4 are values that can be derived from the monitoring information (FIG. 3). However, when an analysis logic that is not recorded in the monitoring information (FIG. 3) is selected in the previous stage of the parameter tuning, the analysis logic is selected for an apparatus having a common type and performance, and a parameter to execute the analysis logic is arbitrarily selected by the operator for the apparatus. As a result, for the target apparatus, a combination of an analysis logic that has been selected in the previous stage of the parameter tuning but has not been recorded in the monitoring information and a corresponding parameter, is recorded in the parameter selection result.

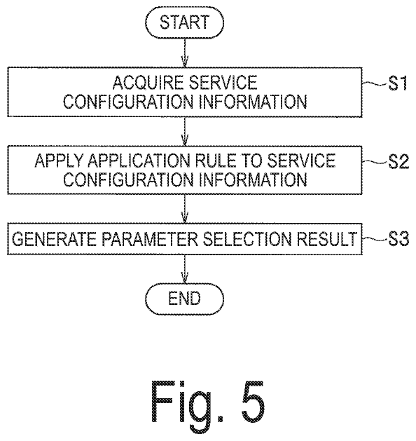

Processing Parameter tuning processing executed by the analysis apparatus 1 of the present embodiment will be described with reference to FIG. 5. The parameter tuning processing starts after a predetermined analysis logic applied to a service on a network is selected by an operator. It is assumed that the monitoring information storage unit 32 stores the monitoring information (FIG. 3) generated at an earlier time than the analysis by the selected analysis logic in the present.

First, the analysis apparatus 1 acquires service configuration information for a service to be analyzed from the input apparatus 2 by the information storage processing unit 21 (step S). The acquired service configuration information is stored in the configuration information storage unit 31.

Next, the analysis apparatus 1 applies an application rule (application rule to perform parameter tuning for selecting a parameter by focusing on load distribution) stored in the application rule storage unit 33 to the service configuration information stored in the configuration information storage unit 31, by the configuration information processing unit 22 (step S2). A processing result when the application rule is applied to the service configuration information is output to the parameter application unit 23.

Next, the analysis apparatus 1 performs parameter tuning on the processing result of the configuration information processing unit 22 by the parameter application unit 23, and generates a parameter selection result (FIG. 4) (step S3).

The parameter tuning processing then ends. The generated parameter selection result is output to the output unit 12 by the result output unit 24.

According to the present embodiment, the parameter tuning based on identity of a type and performance of an apparatus is executed using the service configuration information. Accordingly, the parameter tuning of the analysis logic can be automated. Accordingly, it is possible to reduce the maintenance burden on the operator.

In particular, the parameter tuning focusing on load distribution can be automated.

Others

A technology obtained by suitably combining various technologies described in each of the present embodiments may be implemented.

Software described in each of the present embodiments may be implemented as hardware, and hardware may be implemented as software.

In addition, hardware, software, the flowchart, and the like can be suitably changed without departing from the spirit of the present disclosure.

### REFERENCE SIGNS LIST

1 Analysis apparatus
2 Input apparatus
10 Input/output unit
11 Input unit
12 Output unit
20 Processing unit
21 Information storage processing unit
22 Configuration information processing unit
23 Parameter application unit
24 Result output unit
30 Storage unit
31 Configuration information storage unit
32 Monitoring information storage unit
33 Application rule storage unit
34 Analysis parameter storage unit

1. An analysis apparatus configured to analyze a service on a network, the analysis apparatus comprising:
a storage unit configured to store (i) monitoring information in which an analysis logic for an apparatus disposed on the network and a parameter used to execute the analysis logic are set according to each type of the apparatus and each performance of the apparatus and (ii) an application rule for performing a parameter tuning on each of a plurality of apparatuses used for providing the service and disposed on the network, and
a processing unit configured to acquire service configuration information indicating a network configuration of the plurality of apparatuses used for providing the service and disposed on the network, apply the application rule to the service configuration information, compare the service configuration information with the monitoring information, and select, based on the comparison, an equal analysis logic and an equal parameter for a plurality of the apparatuses having the corresponding type and performance among the apparatuses indicated in the service configuration information.

2. The analysis apparatus according to claim 1,
wherein the apparatuses indicated in the service configuration information include a load balancer,
wherein the analysis logic includes an analysis logic directed to multiple apparatuses for a plurality of the apparatuses under control of the load balancer,
wherein the parameter includes a parameter directed to multiple apparatuses used to execute the analysis logic directed to multiple apparatuses, and
wherein the application rule includes a rule requesting the plurality of apparatuses under control of the load balancer to select the analysis logic directed to multiple apparatuses and the parameter directed to multiple apparatuses.

3. An analysis method used by an analysis apparatus configured to analyze a service on a network, the analysis apparatus including a storage unit configured to store (i) monitoring information in which an analysis logic for an apparatus disposed on the network and a parameter used to execute the analysis logic are set according to each type of the apparatus and for each performance of the apparatus and (ii) an application rule for performing parameter tuning on each of a plurality of apparatuses used for providing the service and disposed on the network, the analysis method comprising:
acquiring service configuration information indicating a network configuration of the plurality of apparatuses used for providing the service and disposed on the network;
applying the application rule to the service configuration information;
comparing the service configuration information with the monitoring information; and
selecting, based on the comparison, an equal analysis logic and an equal parameter for a plurality of the apparatuses having the corresponding type and performance among the apparatuses indicated in the service configuration information.
